(19) United States
(12) Patent Application Publication
(10) Pub. No.: US 2018/0025089 A1
(43) Pub. Date: Jan. 25, 2018

(54) PROFILE-BASED SEARCH RESULTS MODIFICATION

(71) Applicant: Microsoft Technology Licensing, LLC, Redmond, WA (US)

(72) Inventors: Ying N. Chin, Bellevue, WA (US); Robert Yu Zhu, Bellevue, WA (US); Dejun Zhang, Bellevue, WA (US); Bin Wang, Bellevue, WA (US); Satyendra Bahadur, Yarrow Point, WA (US); Pengxiang Zhao, Bellevue, WA (US)

(21) Appl. No.: 15/218,724

(22) Filed: Jul. 25, 2016

(51) Int. Cl. G06F 17/30

(52) U.S. Cl. CPC G06F 17/30867; G06F 17/30702; G06F 17/30675; G06F 17/30705

(57) ABSTRACT

In at least one implementation, the described technology provides a method for improving search results. The method includes generating multiple user profiles based on monitored content navigation history associated with a query set. The user profiles are used to modify search results based on a selected user profile. The selected user profile may be used to send re-queries if the received queries do not satisfy a profile-based condition. The selected user profile may be used to filter, rank, and modify the layout of received results to present the modified results to the user.

### BACKGROUND

Search engines generally return the same results for the same queries entered by different users. Some search engines may return results tailored to a user's geographic location, but the returned results may not be personalized for a particular user unless the user is logged in to the search engine. However, some results returned to the logged in user may not be relevant to the user for the user's particular searching context.

### SUMMARY

In at least one implementation, the described technology provides a system including a user profile generator, a user profile selector, and a profile-based search result modifier configured. The user profile generator is configured to generate multiple user profiles, wherein each user profile is based on a query set and content navigation data associated with the query set. The user profile selector is configured to receive the query entered by the user and select a user profile by classifying the received query into a query set associated with the selected profile. The profile-based search result modifier is configured to modify the search results received by the user based on the selected user profile associated with the query set.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTIONS OF THE DRAWINGS

FIG. 1 illustrates an example implementation of profile-based search results modification.

FIG. 2 illustrates an example implementation of profile generation for profile-based search results modification.

FIG. 3 illustrates another example implementation of profile-based search results modification.

FIG. 4 illustrates an example implementation of profile-based re-querying for profile-based search results modification.

FIG. 5 illustrates example operations for generating profiles for profile-based search results modification.

FIG. 6 illustrates example operations for modification of search results based on a user profile.

FIG. 7 illustrates an example system that may be useful in implementing the described technology.

### DETAILED DESCRIPTIONS

The implementations described herein monitor's user browsing activity on a device to generate one or more profiles for the user. These profiles may be used to personalize search results received at the device by modifying the received search results based on a selected profile. Such modifications may include ranking the received results, filtering the received results, submitting re-queries for more qualified results, and modification of the presented layout of results. Because the user profiles are generated, stored, and utilized within the device, the user information is secure.

As an example, during a search session, a user may spend a period of time searching for and browsing websites related to programming because the user wants to learn software development. The user may enter a number of different queries and navigate to a number of different websites. The system disclosed herein monitors the user queries and website interaction to develop a user profile for a “novice software developer.” The system monitors user interactions in varying levels of navigation. For example, the system monitors user navigation at a first level within search results returned in response to a user entered query. Furthermore, if the user navigates to a page linked within the first level, the system monitors such interaction. All queries related to computer programming and the user's varying levels of content navigation are used to build the “novice software developer” user profile. Other content navigation actions and information may be monitored and collected to build the user profile including, for example, user browsing history, geographical locations, user's interactions with web sites, which section of a web page the user pays more attention, an amount of time user stays on the webpage, the speed of the user's typing, the user's language fluency, etc.

Referring again to the “software developer” example, in a new internet surfing session, the user is interested in learning a scripting language. The user might spend significant time searching PowerShell, python, Pearl, etc., but some results may be advanced, which can be overwhelming and discouraging to the user. In the implementations described herein, the system classifies a user query relating to programming to the “novice software developer” profile. Because of the classification, the “novice software developer” profile is utilized to modify the results received from the search engine. Such modifications may include ranking results related to beginner programming (e.g., tutorials) higher in the presented results and ranking more advanced results lower. The modification may also include filtering irrelevant search results. Moreover, the layout of the presented result may be modified based on the “novice software profile.” These and other implementations are described further with respect to the figures.

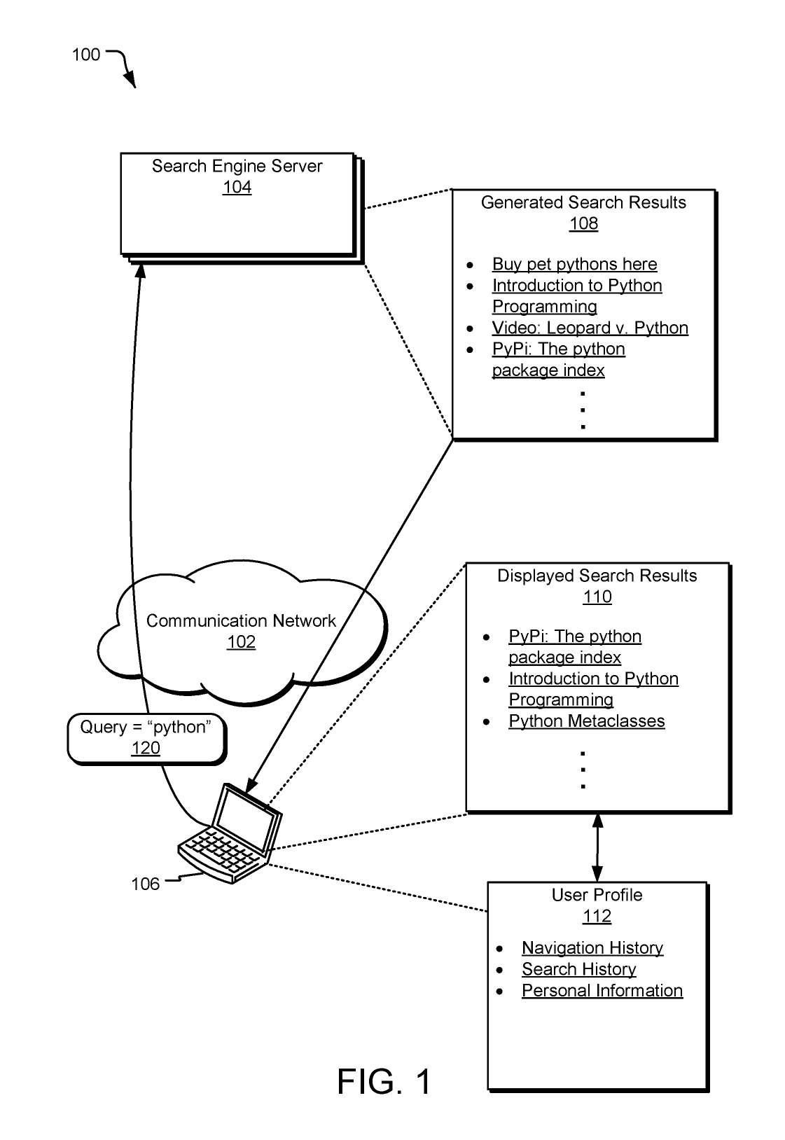

FIG. 1 illustrates an example implementation 100 of profile-based search results modification. The implementation 100 includes a communication network 102, a search engine server 104, and a user device 106. The communication network 102 may include a plurality of electronic devices that facilitate communication between the client devices, such as the user device 106, and the search engine server 104. The communication network may include, internets, intranets, a wide-area networks (WAN), local-area networks (LAN), or any other like computer networks. The user device 106 (illustrated as a laptop), may be a desktop computer, laptop computer, tablet, mobile phone, smart phone, etc. capable of communicating over the communication network 102.

The search engine server 104 may include a plurality of electronic devices that facilitate information storage and retrieval. The search engine server 104 may be a distributed system with remote databases configured to: (1) receive queries over the communication network 102 from a plurality of devices (e.g., the user device 106); (2) generate search results, and (3) send the generated search results to the user device 106.

In the illustrated implementation 100, a query 120 (e.g., the query is “python”) is received from the user via the user device 106 over the communication network 102 at the search engine server 104. The search engine server 104 outputs generated search results 108 in response to the query 120. The search engine server 104 uses its index (not shown) to generate the search results 108, which include results based on python snakes and the python programming language. The generated search results 108 are sent to the user device 106 over the communication network 102.

A search result modification system (not shown) may be embodied in processor executable instructions stored in memory of the user device 106 and executed by a processor of the user device 106. The search results modification system may be implemented as a software system that supports a browser of the user device 106 or may be provided as a service to other applications executing on the user device such as a map, search, or reservation application. It should be understood that the search results modification system may be used in other contexts such as a searching system local to the user device such a local server, database, or searching within the user device 106. The search results modification system receives the generated search results 108 and modifies the presentation and content of the generated search results 108 based on a user profile 112. The modified search results are presented to the user as displayed search results 110. As shown, the displayed search results 110 are different from the generated search results 108. The user profile 112 is generated based upon the user's past queries and content navigation history. Generation of the user profile 112 and use of the user profile 112 to modify the generated search results 108 are described further below.

To generate the user profile 112, a browser (e.g., executing the search results modification system) executing on the user device 106 monitors user queries, user interaction with search results produced by user queries, and browsing history (referred to as “content navigation history”). Moreover, the user profile 112 may be based on personal information provided by the user. As an example, if a user repeatedly enters queries related to python and predominately interacts with search results related to the python programming language (e.g., “Introduction to Python programming” and “PyPi: The python package index”) and does not predominately interact with those results related to a python snake, then the browser utilizes those interactions to generate a user profile for a “computer programmer.” Furthermore, queries that relate to programming are added to a query set, which is associated with the user profile 112 for the “computer programmer.”

The generated user profile 112 can be utilized to modify the generated search results 108 to produce the displayed search results 110. Referring again to the example discussed above, the browser (e.g., the search results modification system) may identify the query 120 (“python”) as being classified to the query set associated with the “computer programmer” profile (e.g., the user profile 112) that was previously generated. The browser may classify the query 120 by employing a number of different classification methods. The browser may receive the generated search results 108 from the search engine server 104 and modify the search results based on the user profile 112.

Such modification may include ranking the search results, filtering the search results, issuing new queries (e.g., re-queries) to generate more relevant results, etc. The generated search results 108 that relate to the python programming language are listed in the displayed search results 110. The two generated search results that relate to a python snake (e.g., “Video: Leopard v. Python” and “Buy pet pythons here”) are filtered and not displayed to the user in the displayed search results 110. Furthermore, a new search result, “Python Metaclasses,” is in the displayed search results 110, which may be the result of a re-query to produce more relevant search results. These and other implementations are described further with respect to the following figures.

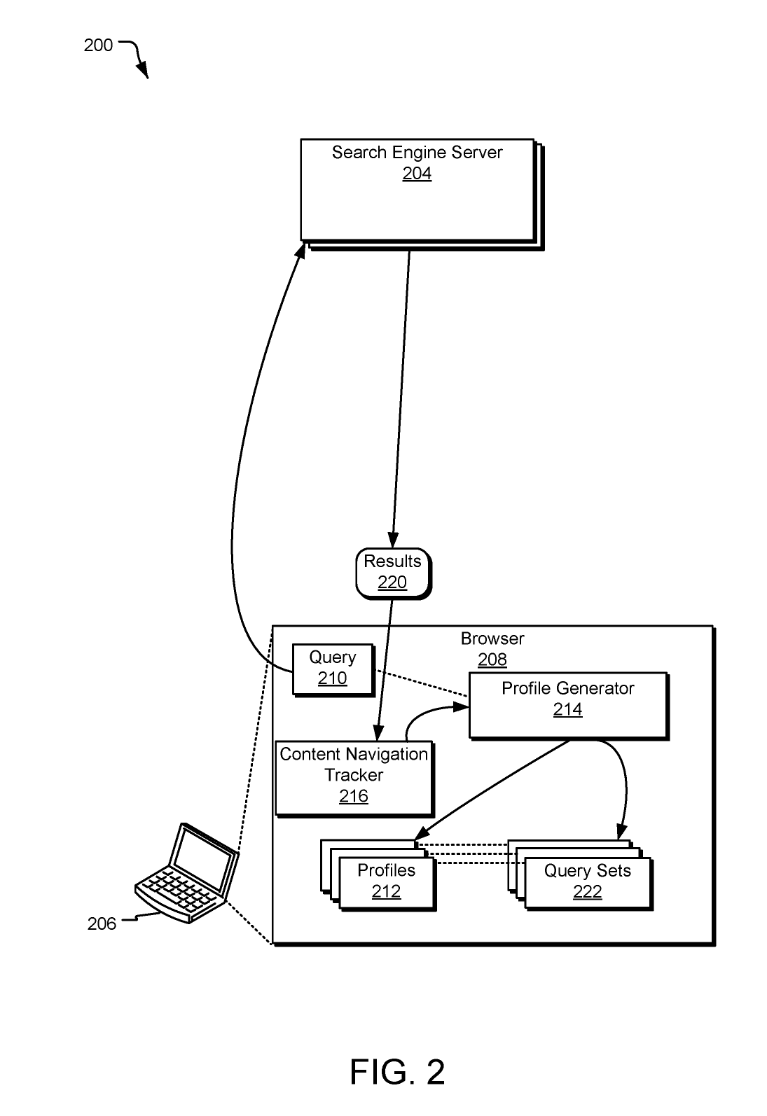

FIG. 2 illustrates an example implementation 200 of profile generation for profile-based search results modification. The implementation 200 includes a search engine server 204 and a user device 206. It should be understood that the implementation includes a communication network. The user device 206 is executing a browser 208, which may be embodied in processor executable instructions stored on tangible computer readable storage media and executed by a processor on the user device 206. The browser 208 includes a content navigation tracker 216 and a profile generator 214.

A user sends a query 210 to the search engine server 204 and receives results 220 generated by the search engine server 204. As the user interacts with the results 220, the content navigation tracker 216 monitors user interaction with the results, and particularly the user's navigation through the content associated with the search results 220 and the query 210. The content navigation tracker 216 may monitor a number of different aspects of user interaction. Such aspects may include browsing history, geographical locations, web pages displayed on the screen, user interactions with websites, which section of the page the user pays more attention to, the time the user stays on the webpage or website, the speed of user's typing, how fluent the user is using the webpage, languages, eye gaze (e.g., using gaze tracking camera and system), pupil dilatation range, etc. Other information may be provided by the user to generate user profiles. Such other information may include the user's age, profession, interests, gender, expertise in profession, etc. Such information and interaction may be used as searching contexts to further modify search results.

In one implementation, when tracking the user navigation, the content navigation tracker 216 increases or decrease weighted interest parameters for certain websites (e.g., results) or subject matter of websites (e.g., a website classification) depending on how the user interacts with the websites. For example, if the user clicks a website and interacts with that website for an extended period, the content navigation tracker 216 increases a weighted interest parameter associated with the website and/or the subject matter presented on the website. Similarly, the content navigation tracker 216 decreases a weighted interest parameter associated with a website if the user ignores the website or clicks the website and quickly exits the website. Moreover, the amount of increase or decrease may depend on how long the user stays on a particular website. For example, if the user spends thirty seconds on a first website and one hour of active navigation within a second website, then the weighted interest parameter attached to the second website may be increased more than the weighted interest parameter attached to the first website. All data generated in relation to user navigation may be stored in association with the user profiles 212. Other navigation tracking and weighting methods may be employed.

The content navigation tracker 216 may analyze visited websites to classify the websites to certain subjects. Such analysis may include, without limitation, using an artificial neural network, a term frequency-inverse document frequency algorithm, concept mining, natural language processing approaches, etc. As the documents are analyzed, the subject matter or classification of the documents may be associated with one or more generated user profiles 212 as content navigation data. Other website classification methods may be employed.

The content navigation data produced by the content navigation tracker 216 and the other information may be used by the profile generator 214 to generate one or more profiles. A number of different user profiles 212 may be generated for a certain user. For example, if a user is an experienced computer programmer, then a profile may be generated for the user as a “computer programmer.” If the user is also a college football fan, then a profile may be generated for the user as a “college football fan.” Each profile is associated with a set of queries (e.g., of query sets 222). For example, each time the user enters queries relating to programming (e.g., “python metaclasses” and “Haskell functional programming”), these queries may be saved into a query set that is associated with the profile for the user as the “computer programmer.” Likewise, queries related to the user as the college football fan may be saved to a query set and associated with the “college football fan” user profile. The system may track the user interactions with search results produced by each query set associated with each profile.

Furthermore, each user profile 212 may have multiple contexts. Such contexts may include the user's location, language, user activities, etc. For example, if the user is at work as a “computer programmer,” then the “computer programmer” profile and “work” context may be used to modify search results. As such, the user at work utilizing the “computer programmer” profile may receive different results than the user at home utilizing the “computer programmer” profile. In another example, the user may be bilingual, and search results may be presented in one or both languages depending on the entered query, the user's location, or other context. Other contexts may be used to modify search results.

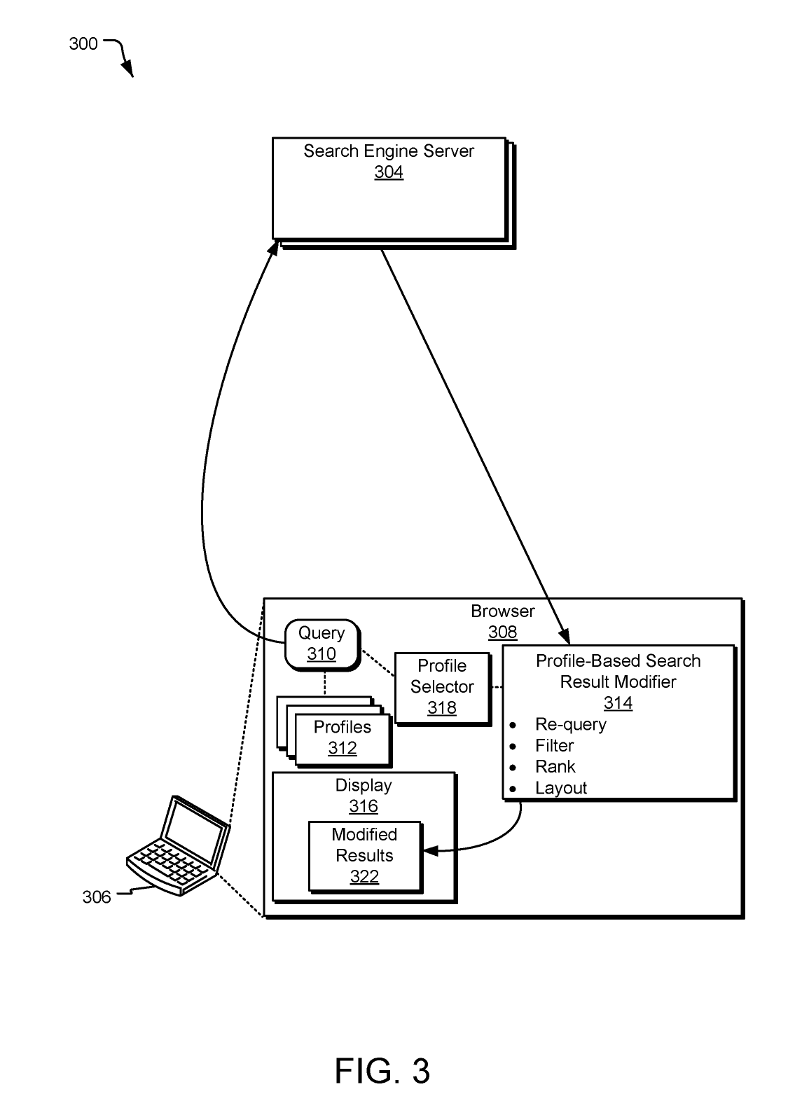

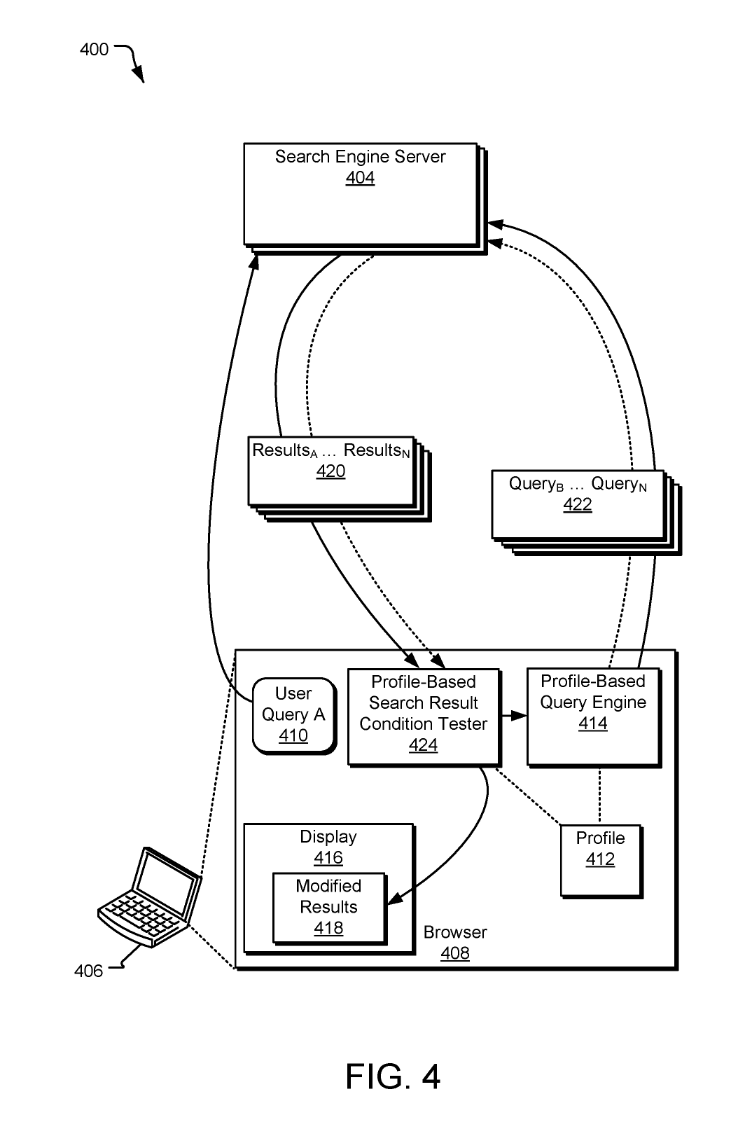

In time, the computer programming profile may be improved and used to modify search results such that relevant results are presented to the user. Likewise, the user profile for the user as a college football fan may be improved over time. For example, if the user usually navigates to pages that relate to southeastern conference football, then the profile will be re-tuned to reflect those interests. The improved tuned profile may be used to modify results. Modification of search results are described further with respect to FIG. 3 and FIG. 4.

In an implementation, the search engine server 204 provides a user interface to the user device 206 configured to present information regarding one or more of the user profiles 212 to the user. Information regarding one or more of the user profiles 212 may include without limitation a description of the user profile, the content of one or more query sets 222 associated with a user profile 212, and/or search results associated with the user profile 212. In one implementation, the search engine server 204 presents a user interface to the user that permits the user to manually modify one or more user profile 212. For example, a user may modify a skill level associated with the “computer programmer” profile to indicate a higher or lower skill level. For example, if the user profile is a “beginning software developer,” the user may modify the user profile to be a “medium skill software developer.” The search engine server 204 may then present accordingly modified search results to the user based on the user modification to the user profile 212.

In an implementation, user modifications to user profiles may be temporary, such as if a user is curious to observe search results corresponding to a higher programming skill level, but does not wish to permanently receive the search results corresponding to a higher programming skill level until his skill has improved. In another implementation, user modifications to a user profile 212 are made permanent, such as if the user believes received search results are too low in comparison to his actual skill level. In yet another implementation, a user modification to a user profile 212 is not permanent, but the user input is taken into account for future modifications of search results. In yet another implementation, a user may temporarily or permanently disable a user profile 212 if the user wishes to observe unmodified search results or if the modified search results associated with the disabled user profile 212 are not the search results the user wishes to see.

FIG. 3 illustrates another example implementation 300 of profile-based search results modification. The implementation 300 includes a search engine server 304 and a user device 306. It should be understood that the implementation includes a communication network. The user device 306 is executing a browser 308, which may be embodied in processor executable instructions stored on tangible processor readable storage media and executed by the processor on the user device 306. The browser 308 includes a profile-based result modifier 314, a display 316, and a profile selector 318.

A user enters a query 310 to the search engine server 304, which generates results 320. Based on the entered query 310, the profile selector 318 classifies the query into a query set associated with a user profile and select the user profile of profiles 312. Such classification of the query may include comparing terms of the entered query to a locally or remotely stored index of queries and query sets by using a machine learning or statistical classifier. For example, a distance or similarity between the entered query 310 and the query sets may be calculated. As such, the entered query 310 may be assigned to (or classified to) a query set based on the query set meeting a distance based condition. Based on the classification of the entered query 310 to a query set associated with a profile, the profile may be selected. Other classification methods may be employed.

Returning again to the “computer programming” example described above, if the user enters a query “python HTTP library,” then the profile selector 318 classifies the query as belonging to the query set associated with the “computer programming” user profile and selects that profile to modify the search results returned from the search engine server 304. Similarly, if the user enters “top returning quarterbacks” as a query, then the profile selector 318 classifies the query as belonging to the query set associated with the “college football fan” user profile” and selects that profile to modify the results returned from the search engine server 304.

The profile-based result modifier 314 receives the results 320 and modifies the results based on the selected profile. Such modifications may include filtering the results 320, ranking the results 320, and changing the layout of the results 320. The modification may also include re-querying the search engine server. Returning again to the “computer programming” example, if the user enters “Python HTTP library,” as a query, the results may include links related to introduction to python programming online courses, advanced HTTP programming in python, and python snakes. In response to receiving the results, the profile-based result modifier 314 may (1) filter the results related to python snakes; (2) rank the results related to advanced HTTP python first and the results related to introduction to python programming online courses second; and (3) modify the layout of the search results. The modifications may also include ranking the frequently visited sites first. For example, if the user spends a lot of time on a certain website related to python programming, then results of that domain name may be listed first. The modifications may be based on a mean confidence level assigned to the returned results, which may be adjusted based on user interaction.

The layout may be modified in a number of ways based on a number of aspects of the user profile. Modification of the layout of results may include increasing the font size or zooming in if the user is of old age. For younger users, a vibrant presentation with touch/audio features enabled may be presented. If the user generally focuses on code snippets within a website, the layout may be modified to show code snippets in the displayed result. The layout may show the first few sentences of text on the webpage or comments on the webpage. It should be understood that other layout modifications may be used. After the results are modified by the profile-based result modifier 314, the results may be displayed in the display 316 as modified results 322, which are customized/personalized for the user based on the entered query 310. The results may be displayed on a screen or other user interface such as being printed from a printer.

In implementations, frequently visited search results and/or frequently entered queries may be cached locally. This cache may be refreshed periodically without the user's knowledge to enhance the user's searching experience. Returning again to the “computer programming” example described above, if the user frequently visits a particular website returned in search results to view tutorials on scripting languages, the website may be cached locally. If the website adds a new tutorial, then the locally cached website may be updated such that the updated website may be presented to the user during a subsequent searching session.

FIG. 4 illustrates an example implementation 400 of profile-based re-querying for profile-based search results modification. The implementation 400 includes a search engine server 404 and a user device 406. It should be understood that the implementation includes a communication network. The user device 406 is executing a browser 408, which may be embodied in processor executable instructions stored on tangible, processor readable storage media and executed by the processor on the user device 406. The browser 408 includes a profile-based query engine 414, a profile-based result condition tester 424, and a display 416. The profile-based query engine 414 and the profile-based result condition tester 424 may form a portion, program module, process, etc. of the profile-based result modifier 314 of FIG. 3.

A user enters a user query A 410 to the search engine server 404. Based on the entered query, the search engine server 404 sends results_{A} 420 to the browser 408. In response, the browser 408 selects a profile 412 associated with the user query A 410. The profile-based result condition tester 424 determines whether the results_{A} 420 satisfy a profile-based condition (e.g., based on the profile 412). The determination may include: (1) a determination of whether a number of the results meet a threshold; (2) whether the quality of the results meet a threshold, etc. For example, the profile-based result condition tester 424 may assign weighted interests to the returned results based on analysis of each returned result. If the results_{A} 420 do not satisfy the profile-based condition (e.g., the average weighted interest of a number of results do not meet the condition), then the profile-based query engine 414 generates a new query_{B} 422 and send the query_{B} 422 to the search engine server 404. The search engine server 404 respond with new results, and the process may be repeated until the results 420 meet the profile-based condition. Once the results satisfy the profile-based condition, the results are filtered, ranked, and the layout may be modified. Modified results 418 may be presented in the display 416. Other quality metrics may be employed to determine whether the results meet the profile-based condition.

The profile-based query engine 414 may generate new queries by refining the previous queries with new information such as preferred website information, user submitted information (e.g., user profession), including Boolean operators, etc. For example, the profile-based query engine 414 may include a NOT operator to exclude irrelevant results. In another example, if the user is bilingual (and the profile 412 knows the information), then the profile-based query engine 414 may generate re-queries to receive and present search results in both languages. The presentation of search results in one or both languages may depend on user's location (e.g., context), for example. The profile-based query engine 414 may also use other contexts to generate re-queries such as the user's location, age, interests, etc. Other query generation methods may be employed.

The generation of user profiles and the modification results may occur in a profile-based search result modifier system supporting the browser 408 and without the search engine server 404 being aware. All profile information may be stored locally, which gives the user privacy protection and allows results to be personalized with using bandwidth to send user information to the search engine server 404. Furthermore, the profiles are continually modified based on user interaction and information such that search results are improving over time and providing increasingly personalized and relevant search results.

The user may take actions with the modified results, which are tracked and the results may be remodified based on the detected actions. For example, the user may interact with a lower ranked result (e.g., the result is weighted below a threshold) or may enter a new query based on the returned results. Another example of a user action includes the user scrolling passed a threshold number of higher ranked results (or clicking the next page of search results) In response, the system may determine that the profile used to modify the results is the wrong profile. In response, the system selects a different profile, resubmits the query, and remodifies the results. Furthermore, if the user detects that the browser has selected a profile and has been presented with search results based on the profile, the user may elect to disable the profile to see results returned from the search engine server 404. Furthermore, the user may be given the option to select a different profile to see results modified based on the user selected profile.

In implementations, the generated user profiles may be sent to the search engine server 404, whereby the search engine server 404 can generate personalized results. This implementation may be optional and at the direction of the user for privacy reasons. Some implementations may generate group profiles. In these implementations, a server may be dedicated to a user group such as a software development team. The dedicated server may monitor the group interactions with search engines and browsing history to generate a group profile. The dedicated server may receive and modify results as described above. In other implementations, user profiles may be shared with the cloud (e.g., search engines) such that similar user profiles may be used to provide relevant results. As such there may be different levels of sharing: personal, between groups, and worldwide.

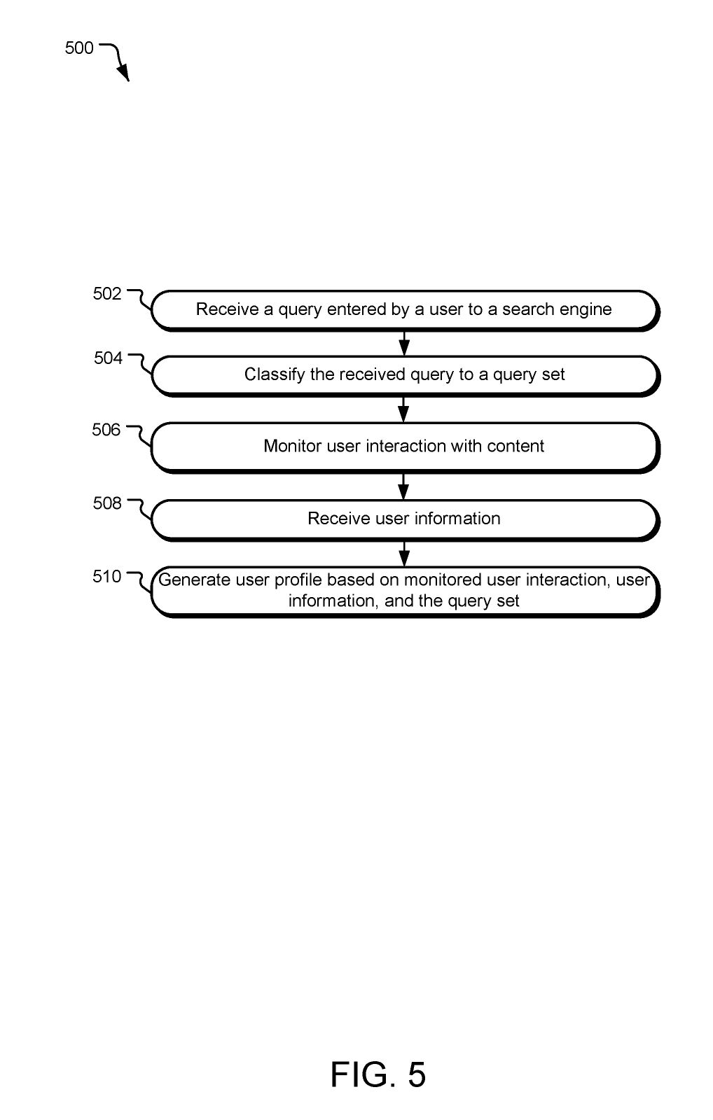

FIG. 5 illustrates example operations 500 for generating profiles for profile-based search results modification. The operations 500 may be embodied in instructions for a profile generator, the instructions being stored in a storage media of a user device and executable by a processor. A receiving operation 502 receives a query entered by a user to a search engine. In classifying operation 504, the browser may capture the query and store it to a previously established query set that is associated with a previously generated profile or the query set may be initiated and associated with a new profile. Classification of the query may include a distance comparison of the query received from the user to the previously generated query sets.

A monitoring operation 506 monitors user interaction with content, including the search results received from the search engine (or from a database, server, or local hard drive). Monitoring may be handled by a content navigation tracker. A number of different aspects of user interaction may be monitored. Such aspects may include, browsing history, locations, pages displayed on the screen, the user's interactions with websites, which section of the page the user pays more attention to, the time the user stays on the webpage or website, the speed of the user's typing, how fluent the user is in using the webpage, input language, eye gaze (e.g., using gaze tracking camera and system), pupil dilatation range, etc. A receiving operation 508 receives user information. Such information may include the user's age, profession, interests, gender, expertise in profession, etc. A generating operation 510 generates a user profile-based on the monitored user interaction with content, the received user information, and the query set.

When monitoring the user interaction in the monitoring operation 506, a content navigation tracker may increase or decrease weighted interest parameters for certain websites (e.g., results) or subject matter discussed by websites depending on how the user interacts with the websites/results. For example, if the user clicks a website and interacts with that website for an extended period, the content navigation tracker may increase a weighted interest parameter associated with the website and/or the subject matter presented on the website. Similarly, the content navigation tracker may decrease a weighted interest parameter associated with a website if the user ignores the website or clicks the website and quickly exits the website. Moreover, the amount of increase or decrease may depend on how long the user stays on a particular website. For example, if the user spends thirty seconds on a first website and one hour of active navigation on the second website, then the weighted interest parameter attached to the second website may be increased more than the weighted interest parameter attached to the first website. Other navigation tracking and weighting methods may be employed

The content navigation tracker may analyze visited websites to classify the websites to certain subjects. Such analysis may include using an artificial neural network, a term frequency-inverse document frequency algorithm, concept mining, natural language processing approaches, etc. As the documents are analyzed, the subject matter or classification of the documents may be associated with one or more generated profiles. Other classification methods may be employed.

The operations 500 may occur multiple times to generate multiple user profiles for one user or one user device. Moreover, the operations 500 may be repeated to strengthen existing profiles and query sets. For example, a user may enter a search query, a profile may be selected based on the query, and results may be modified and presented based on the user profile and query. The monitoring operation 506 may monitor user interaction with the modified search results and use that information to modify the profile. Such modification may strengthen the profile over time such that results may be more tailored for the profile after each search.

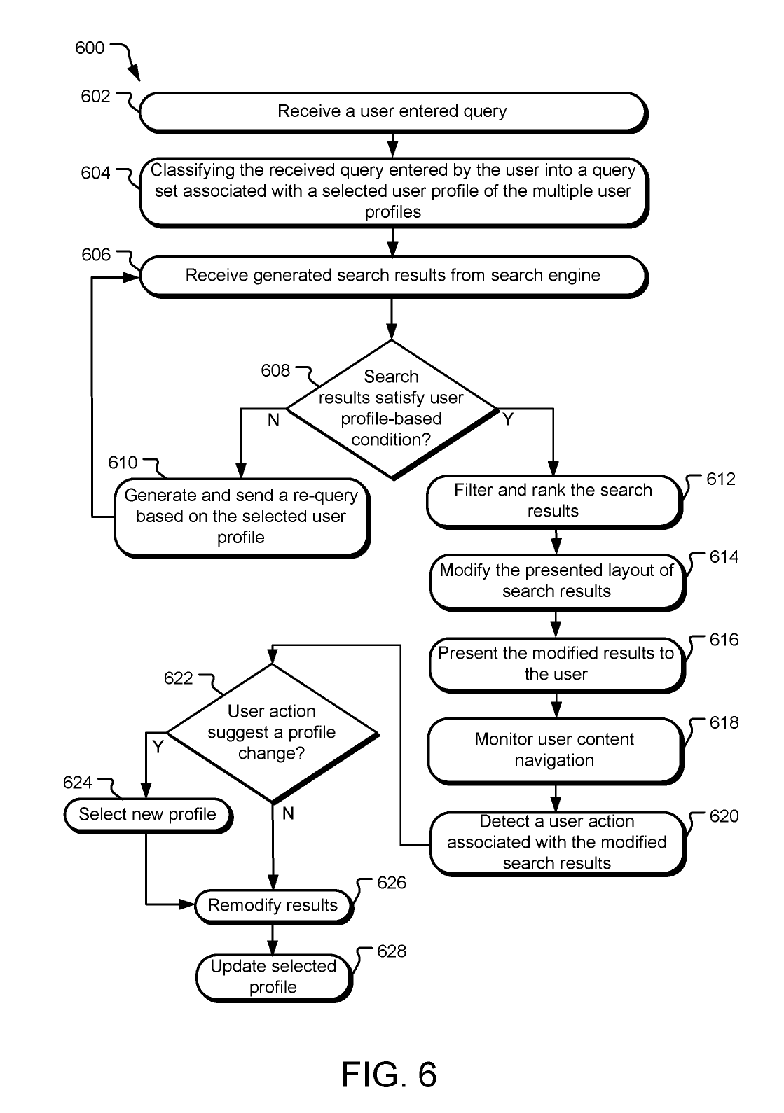

FIG. 6 illustrates example operations 600 for modification of search results based on a user profile. The operations may be embodied in instructions for a profile-based result modifier stored in tangible processor readable storage media of a user device and executable by a processor. A receive operation 602 receives a user entered query. In response to receiving the query, a classifying operation 604 classifies a received query entered by the user into a query set associated with a selected user profile. Such classification may include comparing a distance of the received query to a plurality of query sets and selecting the query set according to the shortest distance. Other classification methods may be employed. The user profile that is associated with that selected query set may be selected for search result modification. Furthermore, the user entered query may be modified before it is released to the search engine, or the original user entered query may be sent to the search engine. A receiving operation 606 receives generated search results from a search engine. An operation 608 determines whether the generated search results satisfy a user profile-based condition. The determination may include: (1) a determination of whether a number of the results meet a threshold; (2) whether the quality of the result meet a threshold, etc. For example, weighted interests may be assigned to the returned results based on analysis of each returned result, and an average of the weighted interests or the weighted interests of the top number of results may be used to compare to the threshold. Other search qualifying methods may be employed. If the generated search results do not satisfy the user profile-based condition, a generating operation 610 generates and sends a re-query based on the selected user profile. Such a re-query may include attributes gathered from the selected user profile such as preferable websites, level of expertise in a field, age, gender, etc. After the re-query is sent, the process returns to the receiving operation 606. Other methods of re-query generation may be employed.

If the generated search results satisfy the user profile-based condition, then a filtering operation 612 filters and ranks the search results based on the selected user profile. Such filtering may include removing disfavored or irrelevant websites. Ranking may include displaying the preferable more relevant websites first, etc. A modifying operation 614 modifies the presented layout of the search results based on the selected user profile. Modification of the presented layout of results may include increasing the font size or zooming in if the user is of old age. For younger users, vibrant presentation with touch/audio features enabled may be presented. The layout may be modified to show code snippets in the result, if the user has a history of focusing on the code snippets of the web page. The layout may show the first few sentences of text on the webpage or comments on the webpage. It should be understood that other layout modifications may be used. The operations 606 to 614 (e.g., referenced by the box 620) may all be referred to search result modifications (e.g., re-querying, filtering, ranking, layout modification). A presenting operation 616 presents the modified search results to the user on a user interface. Such a user interface may include a display, printout, etc.

A monitoring operation 618 monitors user content navigation. Such navigation may include user interaction with the modified search results, user interaction at varying levels of results (e.g., navigation to web sites linked in a result), etc. In the modifying operation 620, the selected user profile may be modified based on the monitored user interaction. As such, the profile is being improved. A detecting operation 620 detects a user action associated with the modified search results. Such user action may include: (1) the user selecting an option to turn the profile-based search results modification system off; (2) the user selecting a different profile for search results modification; or (3) basic user interaction with search results. An operation 622 determines whether the user action suggests a profile change. If the user wants to use a different profile, such an action might include a user selection of a different profile. Another user action that may suggest selecting a different profile may include the user entering a new query because the user is not satisfied with the results. If the user action suggests a profile change, operation 624 selects a new profile. The results may be remodified based on the new profile at operation 626. If the user wants to the turn the profile-based search results modification system off, then results generated by the search engine may be presented. If the user takes an action such as selecting a lower ranked profile, navigating to a second page of results, etc., then the search results may be remodified at operation 626. The search results may also be modified based on the user interaction with higher rank results. For example, if the user spends a significant amount of time on a particular website (e.g., an amount of time above a threshold), then the results may be re-ranked, re-filtered, re-queried, or a layout may be modified based on the particular website. As such when the user returns to the results, the user is presented with more personalized results related to the website of high interest.

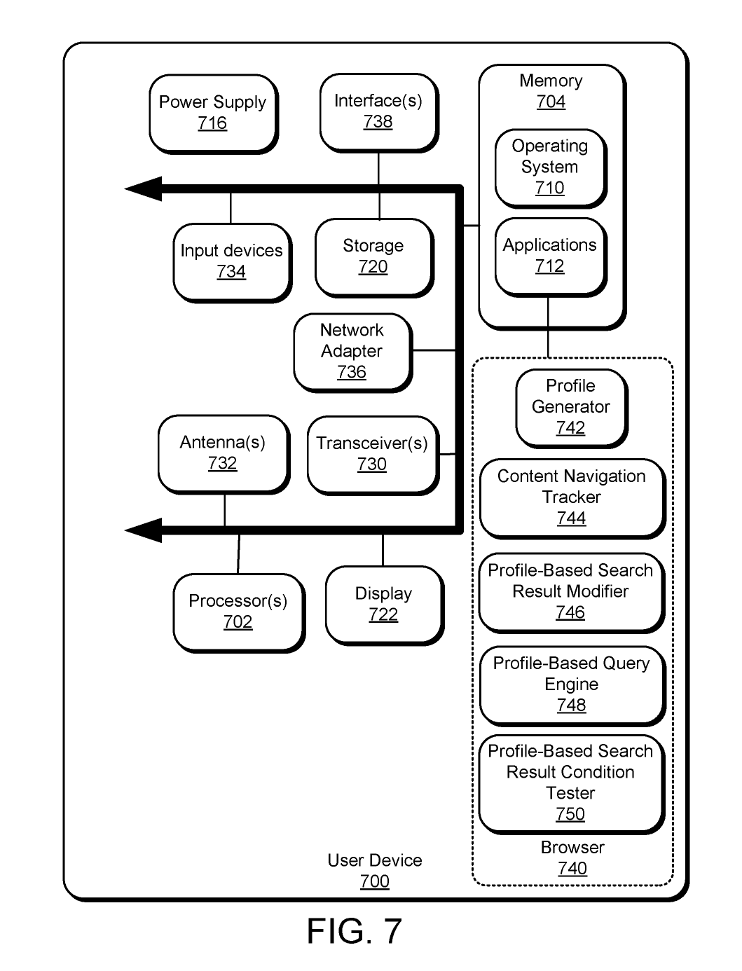

FIG. 7 illustrates an example system (labeled as a user device 700) that may be useful in implementing the described technology. The user device 700 includes one or more processor(s) 702, a memory 704. The memory 704 generally includes both volatile memory (e.g., RAM) and non-volatile memory (e.g., flash memory). An operating system 710 resides in the memory 704 and is executed by the processor 702.

One or more application programs 712 modules or segments, such as a browser 740 are loaded in the memory 704 and/or storage 720 and executed by the processor 702. The browser 740 may include a profile generator 742, a content navigation tracker 744, a profile-based search result modifier 746, a profile-based query engine 748, and a profile-based search result condition tester 750, which may be embodied in instructions stored in the memory 704 and/or storage 720 and executed by the processor 702. Data such user browser/tracking history, profile data such as website preferences and user information, search results, profile-based conditions, query sets, classification data, etc. may be stored in the memory 704 or storage 720 and may be retrievable by the processor 702 for modification of search results. The storage 720 may be local to the user device 700 or may be remote and communicatively connected to the web-user device 700 and may include another server. The storage 720 may store resources that are requestable by client devices (not shown).

The user device 700 includes a power supply 716, which is powered by one or more batteries or other power sources and which provides power to other components of the user device 700. The power supply 716 may also be connected to an external power source that overrides or recharges the built-in batteries or other power sources.

The user device 700 may include one or more communication transceivers 730 which may be connected to one or more antenna(s) 732 to provide network connectivity (e.g., mobile phone network, Wi-Fi®, Bluetooth®, etc.) to one or more other servers and/or client devices (e.g., mobile devices, desktop computers, or laptop computers). The user device 700 may further include a network adapter 736, which is a type of communication device. The user device 700 may use any the adapter and any other types of communication devices for establishing connections over a wide-area network (WAN) or local-area network (LAN). It should be appreciated that the network connections shown are exemplary and that other and communications devices and means for establishing a communications link between the user device 700 and other devices may be used.

The user device 700 may include one or more input devices 734 such that a user may enter commands and information (e.g., a keyboard or mouse). These and other input devices may be coupled to the server by one or more interfaces 738 such as a serial port interface, parallel port, universal serial bus (USB), etc. The user device 700 may further include a display 722 such as a touch screen display.

The user device 700 may include a variety of tangible computer-readable storage media and intangible computer-readable communication signals. Tangible computer-readable storage can be embodied by any available media that can be accessed by the user device 700 and includes both volatile and nonvolatile storage media, removable and non-removable storage media. Tangible computer-readable storage media excludes intangible communications signals and includes volatile and nonvolatile, removable and non-removable storage media implemented in any method or technology for storage of information such as computer readable instructions, data structures, program modules or other data. Tangible computer-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information and which can be accessed by the user device 700. In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared and other wireless media.

An example system for personalizing search results received by a user at a device responsive to a query entered on the device includes a user profile generator configured to generate multiple user profiles where each user profile of the multiple user profiles being based on an associated query set and content navigation history data associated with one or more queries of the associated query set. The example system also includes a user profile selector configured to receive and classify the query entered by the user into a query set associated with a selected user profile of the multiple user profiles and a profile-based search result modifier configured to modify the search results received by the user based on the selected user profile associated with the query set.

Another example device of any preceding device includes a profile-based result modifier configured to modify the search results received from the search engine by filtering the received search results based on the selected user profile.

Another example device of any preceding device includes a profile-based result modifier configured to modify the search results received from the search engine by ranking the received search result to exclude irrelevant search results.

Another example device of any preceding device includes a profile-based result modifier is configured to modify the search results received from the search engine by iteratively generating new queries until the received search results satisfy a user profile-based condition, the new queries generated based on the selected profile.

Another example device of any preceding device includes a user profile selector further configured to select a second user profile of the multiple generated user profiles in response to detection of a user action associated with the modified search results and to remodify the modified search results.

An example tangible processor-readable storage media embodied with instructions for executing on one or more processors and circuits of a device a process for personalizing search results received by a user at the device includes generating a user profiles, the user profile being based on an associated query set and content navigation history data associated with one or more queries of the associated query set, classifying a query entered by the user into a query set associated with the user profile, modifying received search results based on the selected user profile associated with the query set, and presenting the modified search results in a user interface.

Another example tangible processor-readable storage media of any preceding tangible processor-readable storage media includes search results modified based on the selected user profile by iteratively generating new queries until the received search results satisfy a user profile-based condition, the new queries generated based on the selected profile.

Another example tangible processor-readable storage media of any preceding tangible processor-readable storage media includes search results modified based on the selected user profile by filtering the received search results to exclude irrelevant search results.

Another example tangible processor-readable storage media of any preceding tangible processor-readable storage media includes search results modified based on the selected user profile by ranking the received search results.

Another example tangible processor-readable storage media of any preceding tangible processor-readable storage media includes search results modified based on the selected user profile by reconfiguring a layout of the received search results.

Another example tangible processor-readable storage media of any preceding tangible processor-readable storage media includes selecting a second user profile in response to a user action associated with the modified search results, and remodifying the modified search results.

Another example tangible processor-readable storage media of any preceding tangible processor-readable storage media includes modifying the selected user profile based on content navigation data associated with user interaction with the presented modified search results.

Another example tangible processor-readable storage media of any preceding tangible processor-readable storage media includes each user profile further based on information submitted by the user.

An example method includes generating multiple user profiles, each user profile of the multiple user profiles being based on an associated query set and content navigation history data associated with one or more queries of the associated query set, classifying the query entered by the user into a query set associated with a selected user profile of the multiple user profiles, modifying received search results based on the selected user profile associated with the query set, and presenting the modified search results in a user interface.

Another example method of any preceding method includes iteratively generating new queries until the received search results satisfy a user profile-based condition, the new queries generated based on the selected user profile.

Another example method of any preceding method includes filtering the received search results to exclude irrelevant search results.

Another example method of any preceding method includes modifying the search results based on the selected user profile by ranking the received search results.

Another example method of any preceding method includes modifying the search results based on the selected user profile by reconfiguring a layout of the received search results.

Another example method of any preceding method includes each user profile is further based on information submitted by the user.

Another example method of any preceding method includes selecting a new user profile in response to a user action associated with the modified search results, and remodifying the modified search results.

An example system includes means for generating multiple user profiles. Each user profile of the multiple user profiles is based on an associated query set and content navigation history data associated with one or more queries of the associated query set. The example system also includes means for classifying the query entered by the user into a query set associated with a selected user profile of the multiple user profiles, means for modifying received search results based on the selected user profile associated with the query set, and means for presenting the modified search results in a user interface.

An example system of any preceding system further includes means for iteratively generating new queries until the received search results satisfy a user profile-based condition, the new queries generated based on the selected user profile.

An example system of any preceding system further includes means for filtering the received search results to exclude irrelevant search results.

An example system of any preceding system further includes means for modifying the search results based on the selected user profile by ranking the received search results.

An example system of any preceding system further includes means for modifying the search results based on the selected user profile by reconfiguring a layout of the received search results.

An example system of any preceding system is configured such that each user profile is further based on information submitted by the user.

An example system of any preceding system further includes means for selecting a new user profile in response to a user action associated with the modified search results, and remodifying the modified search results.

Some embodiments may comprise an article of manufacture. An article of manufacture may comprise a tangible storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one embodiment, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain operation segment. The instructions may be implemented using any suitable high-level, low-level, object-oriented, visual, compiled and/or interpreted programming language.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language.

What is claimed is:

1. A system for personalizing search results received by a user at a device responsive to a query entered on the device, the system comprising:
a user profile generator configured to generate multiple user profiles, each user profile of the multiple user profiles being based on an associated query set and content navigation history data associated with one or more queries of the associated query set;
a user profile selector configured to receive and classify the query entered by the user into a query set associated with a selected user profile of the multiple user profiles; and
a profile-based search result modifier configured to modify the search results received by the user based on the selected user profile associated with the query set.

2. The system of claim 1 wherein the profile-based result modifier is configured to modify the search results received from the search engine by:
filtering the received search results based on the selected user profile.

3. The system of claim 1 wherein the profile-based result modifier is configured to modify the search results received from the search engine by:
ranking the received search result to exclude irrelevant search results.

4. The system of claim 1 wherein the profile-based result modifier is configured to modify the search results received from the search engine by:
iteratively generating new queries until the received search results satisfy a user profile-based condition, the new queries generated based on the selected profile.

5. The system of claim 1 wherein the user profile selector is further configured to:
select a second user profile of the multiple generated user profiles in response to detection of a user action associated with the modified search results; and
remodify the modified search results.

6. One or more tangible processor-readable storage media embodied with instructions for executing on one or more processors and circuits of a device a process for personalizing search results received by a user at the device, the process comprising:
generating a user profile, the user profile being based on an associated query set and content navigation history data associated with one or more queries of the associated query set;
classifying a query entered by the user into a query set associated with the user profile;
modifying received search results based on the user profile associated with the query set; and
presenting the modified search results in a user interface.

7. The one or more tangible processor-readable storage media of claim 6 wherein the search results are modified based on the selected user profile by:
iteratively generating new queries until the received search results satisfy a user profile-based condition, the new queries generated based on the selected profile.

8. The one or more tangible processor-readable storage media of claim 6 wherein the search results are modified based on the selected user profile by:
filtering the received search results to exclude irrelevant search results.

9. The one or more tangible processor-readable storage media of claim 6 wherein the search results are modified based on the selected user profile by:
ranking the received search results.

10. The one or more tangible processor-readable storage media of claim 6 wherein the search results are modified based on the selected user profile by:
reconfiguring a layout of the received search results.

11. The one or more tangible processor-readable storage media of claim 6 the process further comprising:
selecting a second user profile in response to a user action associated with the modified search results; and
remodifying the modified search results.

12. The one or more tangible processor-readable storage media of claim 6 the process further comprising:
modifying the selected user profile based on content navigation data associated with user interaction with the presented modified search results.

13. The one or more tangible processor-readable storage media of claim 6 wherein each user profile is further based on information submitted by the user.

14. A method for personalizing search results received by a user at a device responsive to a query entered by the user on the device, the method comprising:
generating multiple user profiles, each user profile of the multiple user profiles being based on an associated query set and content navigation history data associated with one or more queries of the associated query set;
classifying the query entered by the user into a query set associated with a selected user profile of the multiple user profiles;
modifying received search results based on the selected user profile associated with the query set; and
presenting the modified search results in a user interface.

15. The method of claim 14 wherein the search results are modified based on the selected user profile by:
iteratively generating new queries until the received search results satisfy a user profile-based condition, the new queries generated based on the selected user profile.

16. The method of claim 14 wherein the search results are modified based on the selected user profile by:
filtering the received search results to exclude irrelevant search results.

17. The method of claim 14 wherein the search results are modified based on the selected user profile by:
ranking the received search results.

18. The method of claim 14 wherein the search results are modified based on the selected user profile by:
reconfiguring a layout of the received search results.

19. The method of claim 14 wherein each user profile is further based on information submitted by the user.

20. The method of claim 14, further comprising:
selecting a new user profile in response to a user action associated with the modified search results; and
remodifying the modified search results.
